(19) United States
(12) Patent Application Publication
(10) Pub. No.: US 2018/0060017 A1
(43) Pub. Date: Mar. 1, 2018

(54) Computerized Contact Management Systems and Methods

(71) Applicant: Gary Lauck, Virginia Beach, VA (US)

(72) Inventor: Gary Lauck, Virginia Beach, VA (US)

(21) Appl. No.: 15/690,823

(22) Filed: Aug. 30, 2017

Related U.S. Application Data
(60) Provisional application No. 62/381,234, filed on Aug. 30, 2016.

(51) Int. Cl. G06F 3/14; H04L 29/08; H04L 29/12; H04M 1/274

(52) U.S. Cl. CPC G06F 3/1454; H04L 67/1095; G06F 3/0482; H04M 1/274; H04L 61/304

(57) ABSTRACT

A contact management system in which a user can select a related group of contract information and, in a single user action, share the contact information to another user device such that the data relating to each of the contacts assigned to the group is automatically updated in the receiving device. In addition, the contact management system enables the creation, display, and sharing of hierarchical relationships between contacts in the data set such that a user can easily communicate and view those relationships for a group of related contacts.

### BACKGROUND OF THE INVENTION

The present subject matter relates generally to a contact management system. More specifically, the present invention relates to both computerized contact management systems and methods which are capable of sharing and synchronizing contact information across multiple end user accounts and/or devices.

Remembering names can be difficult. Sometimes one cannot recall a bartender's name at their favorite spot or can only remember a plumber's first name which is unhelpful when managing todays contact lists. When meeting new people, people typically want to retain and build upon the acquired information. Few things are more embarrassing than being unable to recall someone's name the next time you see them.

A few business applications have come out for helping salespersons remember details about their clients: favorite foods, hobbies, etc. These applications are very specific to the corporate world and not useful to the general population. Another application uses mnemonics to remember people's names but is also not particularly useful.

Accordingly, there is a need for computerized contact management systems and methods which are capable of sharing and synchronizing contact information across multiple end user accounts and/or devices, as described herein.

### BRIEF SUMMARY OF THE INVENTION

To meet the needs described above and others, the present disclosure provides computerized memory assistance systems and methods capable of sharing and synchronizing contact information across multiple end user accounts and/or devices.

The present invention, described in one embodiment as “PastZero”, the name for a computerized mobile device application which provides one place to retain important information about contacts. The application and associated system function by presenting groups of contacts to an end user. Each of these groups of contacts can be described by various attributes (e.g., friends from the gym, work contacts, consumer electronics expo attendees) which aid an end user in remembering people they have encountered.

The application provides a simple, organized database to assist in recalling acquaintances, clients and family members. It's like having a rolodex with you at all times, but with a more efficient search and recall aiding capability and no complicated gimmicks nor need for mnemonics to help remember people and their names.

One embodiment of the present system enables data about various contacts to be recorded and organized in a uniquely functional manner. As mentioned above, users are able to group new contacts, friends, or acquaintances into memorable and easily retrievable blocks of information: Bowling league, PTA, local church, work place, the book club, golf and poker buddies, family, neighborhood, etc. The application may feature cards which are a person's point of contact (POC) information in electronic form. A card can contain as much or as little information as an individual chooses to share. A user can create cards with different levels/types of information.

The application (of this system embodiment) also features different modes, which allow for the sharing of contact information. For example, in a “I am available” mode, a person's contact card is held in a queue until the intended recipient(s) of the card place it into a group. In “Networking” mode, a group that is created for an event, etc. shows up in a list of groups in each user's instance of the application and all cards of users associated with the event, etc. will populate under that group (bypass the queue and need for manual sorting). In other mode(s), a “host” user may retain all contact data the same way as the “Networking” mode, while each guest receives only the host's card.

Additionally, when a user creates a group, the system may enable each member of a given group to update their contact information in real time across all the user accounts/devices of all the group members. For example, if a group of friends from a business school all create accounts to access the system and in turn create a group titled “New York Business School Class of 2015”, each of the users may upload their contact card featuring various details about themselves. Each member that belongs to the group may access the contact information of all other users within the group and the contact information stored by the system for each user may be used to update the contact information in a mobile phone, etc. in real time in response to a user updating there contact card. Practically, this would mean if a member of the group changed jobs, mailing address, etc. this information could be automatically populated across all the devices of other end users in the group, ensuring everyone has the most up-to-date contact information for each group member.

An embodiment of the presently disclosed system may also be described as a contact management system comprising a first user device including a first processor and a first memory coupled to the first processor, wherein the first memory stores program instructions that when executed by the first processor cause the first processor to display a first graphical user interface through which a first set of contact information is accessed, the first set of contact information including first data relating to each of a plurality of contacts. The first data relates to each of the plurality of contacts including at least a unique contact identifier data field, a user selectable group assignment data field, and additional data fields related to the unique contact identifier, and provide a first group assignment user control through the first graphical user interface through which a first user assigns at least two of the unique contact identifiers to a first group of contact identifiers, the first group of contact identifiers including a first unique group identifier.

This embodiment of the system also features a second user device including a second processor and a second memory coupled to the second processor, wherein the second memory stores program instructions that when executed by the second processor cause the second processor to display a second graphical user interface through which a second set of contact information is accessed, the second set of contact information including second data relating to each of a plurality of contacts. The second data relates to each of the plurality of contacts including at least a unique contact identifier data field, a user selectable group assignment data field, and additional data fields related to the unique contact identifier.

This embodiment of the system also provides a second group assignment user control through the second graphical user interface through which a second user assigns two of the unique contact identifiers to a second group of contact identifiers, the second group of contact identifiers including the first unique group identifier, provides a share group user control through the second graphical user interface through which the second user selects the second group of contract identifiers and, in a single user action, the second user device shares to the first user device the data relating to each of the plurality of contacts assigned to the second group with the first user device, thereby updating the data relating to each of the plurality of contacts assigned to the second group in the first set of contact information accessible through the first user device.

In this embodiment of the system, the first set of contact information and the second set of contact information may include a common unique contact identifier. The second user device may share to the first user device, the data relating to each of the plurality of contacts assigned to the second group with the first user device, all data related to the plurality of contacts assigned to the second group is shared. The second user device may also share to the first user device the data relating to each of the plurality of contacts assigned to the second group with the first user device, less than all data related to the plurality of contacts assigned to the second group is shared. The first graphical user interface may provide an update control mechanism through which the first user enables edits to be pushed to the second user device and the first user may enable edits to be pushed to the second user device, the edits are automatically pushed to the second user device when the edits are made through the second user device.

This embodiment of the system may also allow the first user to enable edits to be pushed to the second user device, the edits are manually pushed to the second user device. The first graphical user interface may also provide an update control mechanism through which the first user enables edits to be received from the second user device. The first user may also enable edits to be received from the second user device, the edits are automatically received from the second user device when the edits are made through the second user device. The first user may still yet also enable edits to be received from the second user device, the edits are manually received from the second user device. The first data relating to each of the plurality of contacts and the second data relating to each of the plurality of contacts may include data defining one or more hierarchical relationships between at least two unique contact identifiers. The first graphical user interface may also include a display hierarchy control that, when selected, displays a visual representation of the one or more hierarchical relationships between the at least two unique contact identifiers. The first graphical user interface may also display only the one or more hierarchical relationships between the at least two unique contact identifiers for a selected group of contact identifiers.

A goal of the present invention is to improve computerized contact management by providing a system (or method) which enables contact information to be grouped, shared, and updated in an extremely efficient manner. The rolodex used to be the most valuable tool to many businesses as having an easily accessible set of data regarding business contacts was invaluable. The rolodex also enabled users to group contacts based off various types of metadata concerning the contacts (e.g., all plumbers in one section of the rolodex, doctors in another). However, this static storage of contact information created issues whenever a contact moved offices, changed their contact information, etc. This issue persists even in the digital age, as there is presently no effective way to manage contact information and keep it synchronized across the end user devices of multiple independent users. Additionally, the ability to group contacts based off metadata, common attributes, etc. (seen with the rolodex) is missing from modern smartphones, etc.

An advantage of the present system is that is automates what can be a tedious task. Updating contact information for a large number of contacts using modern smartphone and tablet interfaces is inefficient to say the least. While it is relatively easy to update a single contact, if, for example, a professor was to attend a conference and meet 100 colleagues, sharing contact information amongst all of them would take an enormous amount of effort.

Yet another advantage of this invention is that every person of importance (to a user) that is met can potentially be recorded in one place (the system) for assistance with recollection. Whether located by their first, last name, photo, or a group that they belong to—contacts are easy to locate and sort. The grouping based off common attributes is a powerful tool as many times the context of where a person was met is easier to recall than their name, face, phone number, etc.

Additional objects, advantages, and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

FIG. 1A is an overview diagram of a computerized contact management system.

FIG. 1B is an overview diagram of an alternative embodiment of a computerized contact management system.

FIG. 2 is a flowchart of how contact information may be shared between users of the computerized contact management system.

FIG. 3 is a screen of the computerized contact management system's GUI.

FIG. 4 is a contact card creation screen of the computerized contact management system's GUI.

FIG. 5 is a screen of the computerized contact management system's GUI in which all contact cards an end user has collected can be viewed.

FIG. 6 is a screen of the computerized contact management system's GUI in which all groups of contact cards an end user has accumulated can be viewed.

FIGS. 7A-7B is a screen of the system GUI in which an end user may share their contact card with other system user(s).

FIGS. 8A-8C is a group creation screen of the system GUI utilized to create a conference group.

FIGS. 9A-9C is a group creation screen of the system GUI utilized to create a social group.

FIG. 10 is a diagram of how the system maps contact cards based on hierarchical data.

### DETAILED DESCRIPTION OF THE DRAWINGS

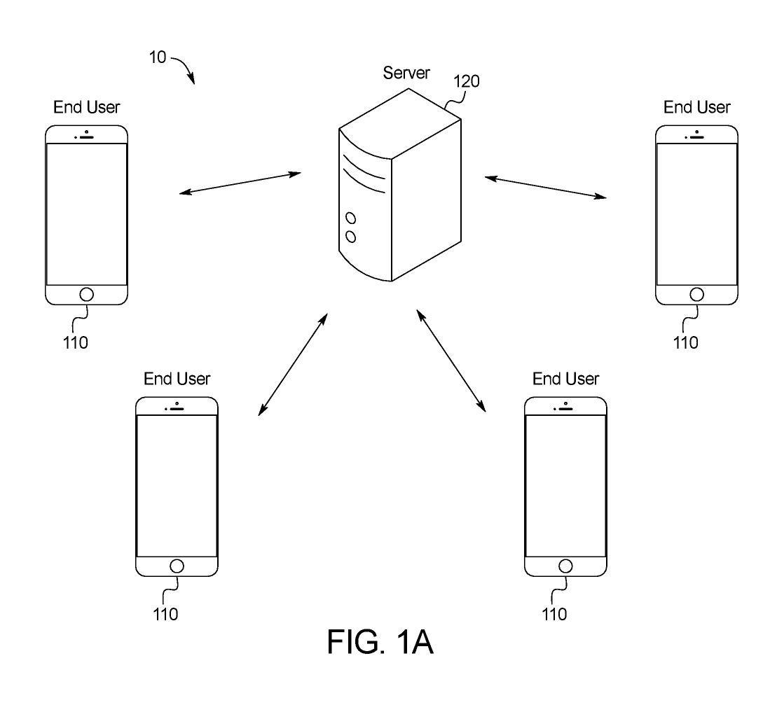

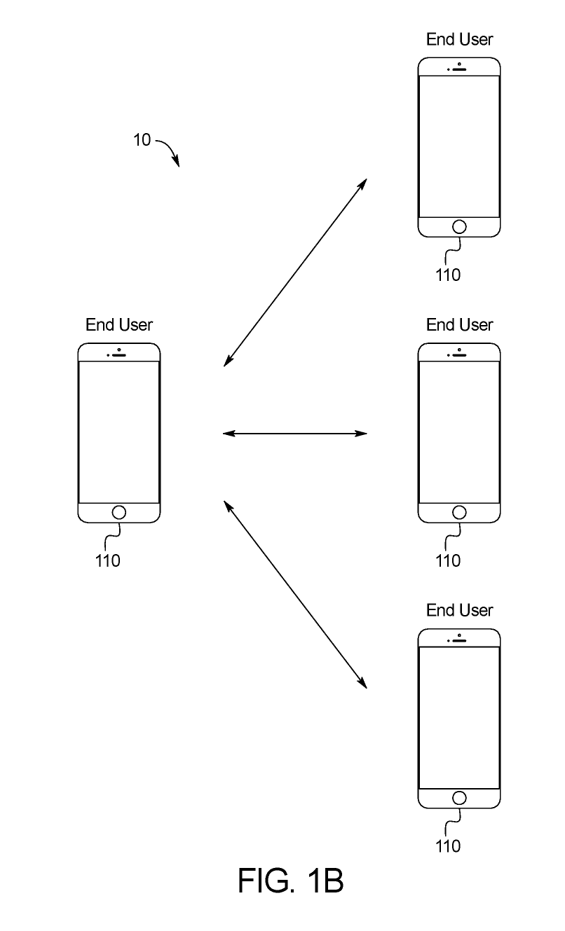

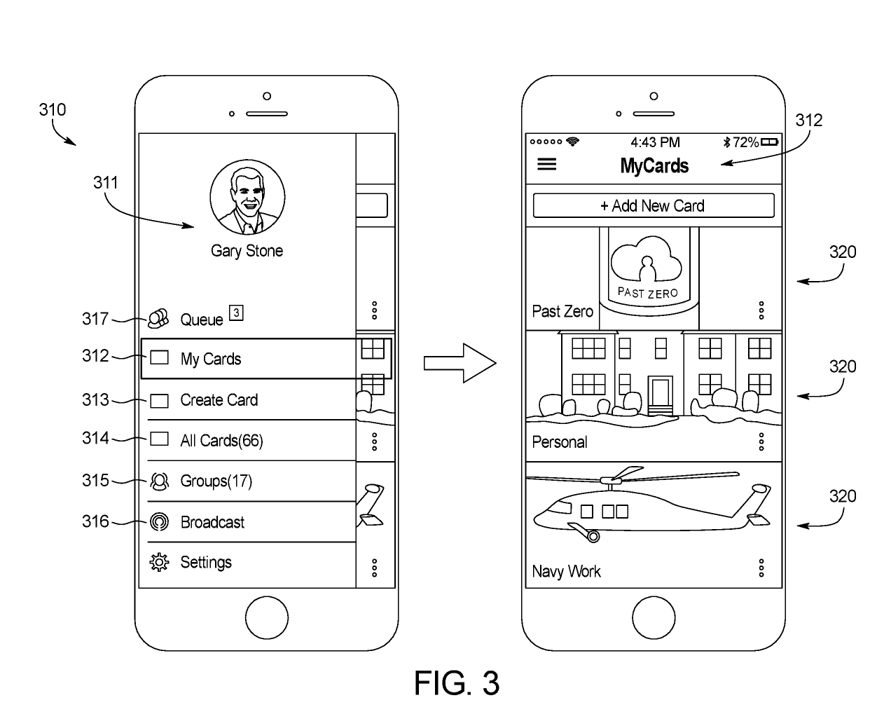

FIG. 1A is an overview diagram of a computerized contact management system 10. As shown in FIG. 1A, the presently disclosed system 10 may feature a plurality of end user devices 110 and a centralized server 120. Each of the end user devices 110 may be in communication with the centralized sever 120 via the internet and/or any other means of networking communication (e.g., Bluetooth, ZigBee, NFC, RFID, etc.). The end user devices 110 may be smartphones, tablets, other mobile computing devices, laptops, and/or personal computers. These end user devices 110 may feature a processor, memory, network communication interface, and a graphical user interface (GUI) 310. This end user device 110 GUI 210 (pictured in FIGS. 3-8) enables end users to interact with the system 10 by uploading, updating, and sharing contact information with other system users.

The data regarding the contact information uploaded, shared, and obtained by each end user may be stored within the memory of a given end user's device 110 and also within the centralized server 120. The centralized sever 120 may feature a processor, memory, and network communications interface. The memory of the centralized server 120 may store one or more databases of the contact information data as well as contextual information about the contact information (e.g., one set of contact information is from a plumber, another set of contact information is from a colleague met in Barcelona, etc.). The database(s) may also store account information for each system 10 end user such as login details, contacts cards 320 collected by each login account, etc. The end user device(s) 110 may access the data associated with their accounts via the system's 10 end user device GUI 310.

It should be noted that while the present example shown in FIG. 1 features a single physical server 120, the server 120 may be multiple physical servers or cloud based. Additionally, the account information for a given user may be accessed by more than one end user device enabling the system to keep contact information collected and stored by an end user account consistent across all devices associated with that particular end user account. It is also important to note that the various components of the present system 10 may be assimilated as technology advances and/or a given application of the system 10 warrants the need for more streamlined or complex system 10 instillations. For example, each end user device 110 may act as its own server 120, broadcasting and collecting contact information of other system 10 end users without the need for a physical stand-alone server 120.

FIG. 1B is an overview diagram of an alternative embodiment of a computerized contact management system 10. As shown in FIG. 1B, in some instances, the presently disclosed system may be implemented via only end user devices 110. In this example, one user device is sending and receiving contact information data from multiple other ends user devices 110. The transmission of this data may be done by any functional means which enable transmission of computerized contact information data and, in preferred embodiments, may include the use of Bluetooth, ZigBee, NFC, RFID, etc. The system 10 is also fully envisioned to use features of modern smartphones such as Apple AirDrop to share contact information as well as more traditional means of sharing information (e.g., email hyperlinks, SMS messaging, etc.).

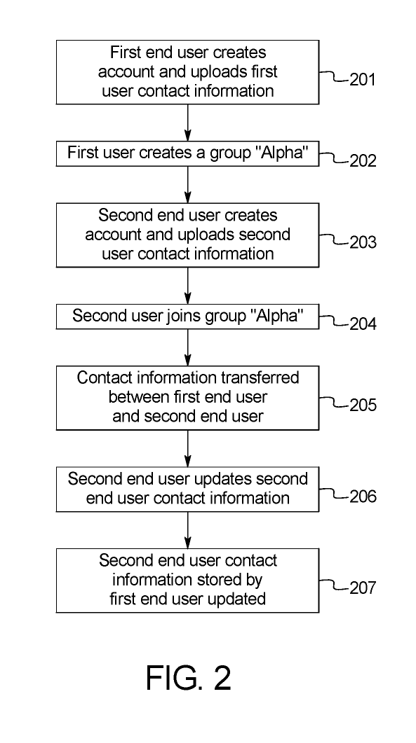

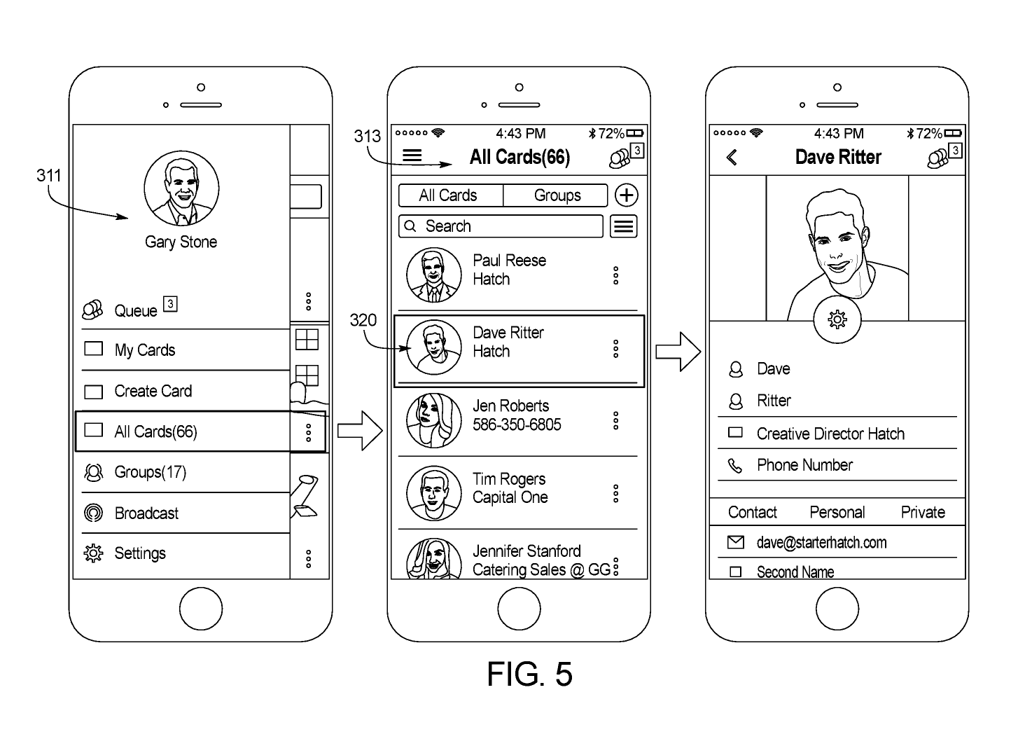

FIG. 2 is a flowchart of how contact information may be shared between users of the computerized contact management system 10. As shown in FIG. 2, at a first step 201 a first end user creates a unique login account via the GUI 310 of the system 10. This login account contains information related to the user's own contact information, preferences, etc. The user may input a single set of contact information for themselves, or create separate sets of contact information (work, personal, etc.) to share on the system 10 depending on the situation (see FIG. 3). Once a first end user creates their account, they may, as a second step 202, then create a group (see FIG. 5) for sharing their contact information with others. The settings for this group may be determined by the first end user (e.g., access code, sharing settings, maximum number of group members, blocked users, etc.). Once a group is created, other users of the system 10, with separate unique login accounts, may join the groups created by other users. This is shown as step 204 (after a second user's account creation, step 203). Once two or more end users are within a given group, the system 10 will transfer the contact information from each user to all other users within a given group (step 205). Once the contact information is shared between the users, the system 10 will monitor the accounts of each user in a given group for any updates to their respective contact information. Once an end user updates their contact information (step 206), the change in contact information is transmitted to all other group users (step 207) to keep the contact information stored by the system 10 (and disseminated from it) as up to date as possible.

As noted previously, the system 10 may also share contact information directly between end user devices 110, with the system 10 updating contact information as needed based off the data broadcasted from an end user device.

FIG. 3 is a screen of the computerized contact management system's 10 GUI 310. As shown in FIG. 3, when a user launches the end user GUI 310 on their respective end user device(s) 110, they are prompted with a screen which enables them to login and view their own accounts information. From this account management screen 311 a user can access various other GUI 310 screens including the user's own contact cards 312, a card creation screen 313, all contact cards the user had collected 314, a list of contact groups 315, and a broadcast contact information screen 316. If an end user opts to view their own contact cards, they are taken to the My Cards screen 312. On this screen of the GUI 310, users can view each of the contact cards 320 they have created within the system. Each contact card 320 contains contact information for a given user including details such as name (e.g., a unique contact identifier data field), phone number, email addresses, and physical addresses. The contact card 320 may also include additional details such as demographic data, organizational data, images of the end user (e.g., one in a Hawaiian shirt for personal use, one in a suit for business use), etc. Each contact card may further include a user selectable group assignment data field (see FIG. 5 for examples of groups 330), and additional data fields related to the unique contact identifier (e.g., notes). The GUI 310 also features a queue 317 screen which enables users to accept or reject contact cards 320 provided to them by other users.

As shown in FIG. 3, the end user has three different contact cards 320 created for different interpersonal reactions. These include cards 320 for contact information at a software company, contact information for personal use, and contact information in a military role. Each of these cards 320 may be shared to other end users directly or through groups of contacts (see FIG. 5-9).

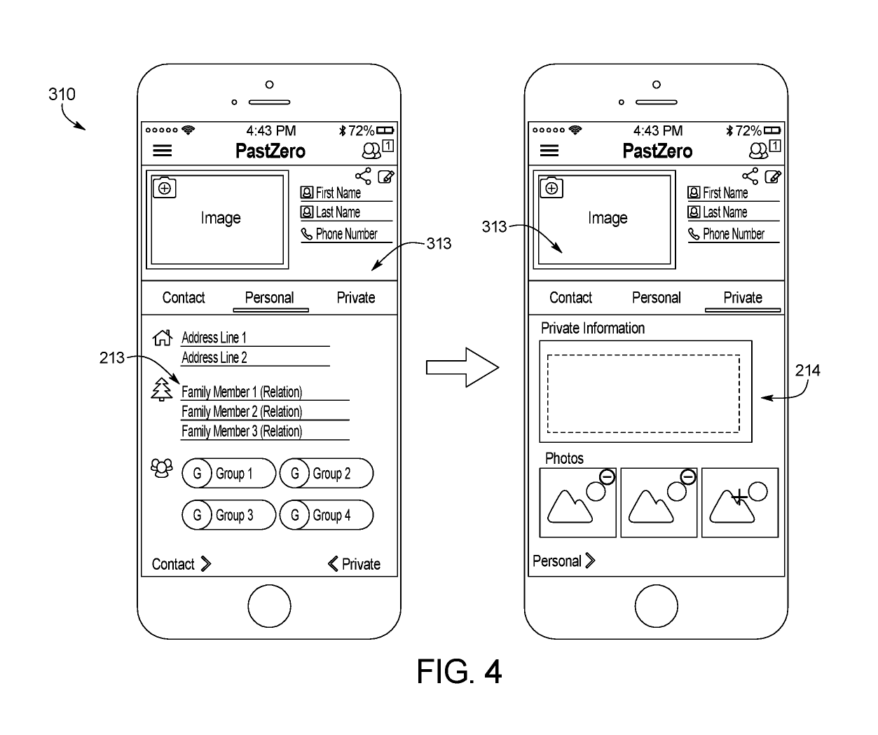

FIG. 4 is a contact card 320 creation screen 313 of the computerized contact management system's 10 GUI 310. As shown in FIG. 4, the contact card creation screen 313 enables end users to create contact cards 320 for themselves and create and/or edit contact cards 320 of other system 10 users. In the embodiment shown, each contact card 320 created (or edited) by a given end user may contain the contact information of a user and also some data fields for contextual information about the user (e.g., information that places them into social context). For example, the data fields 213 concerning family member relation shown can help an end user place a contact into context which will be useful when remembering them and also improve efficiency when attempting to contact that person. The groups 330 a given contact belongs to are also listed on the contact card creation screen and from here, users can quickly review and add a contact card 320 to one of more groups of contacts 330. It should be noted the “family relation” data fields 213 can be any sort of relation between contacts (e.g., business organization hierarchy, family relation, sports team roles, etc.) depending on the context within which the system 10 is being utilized.

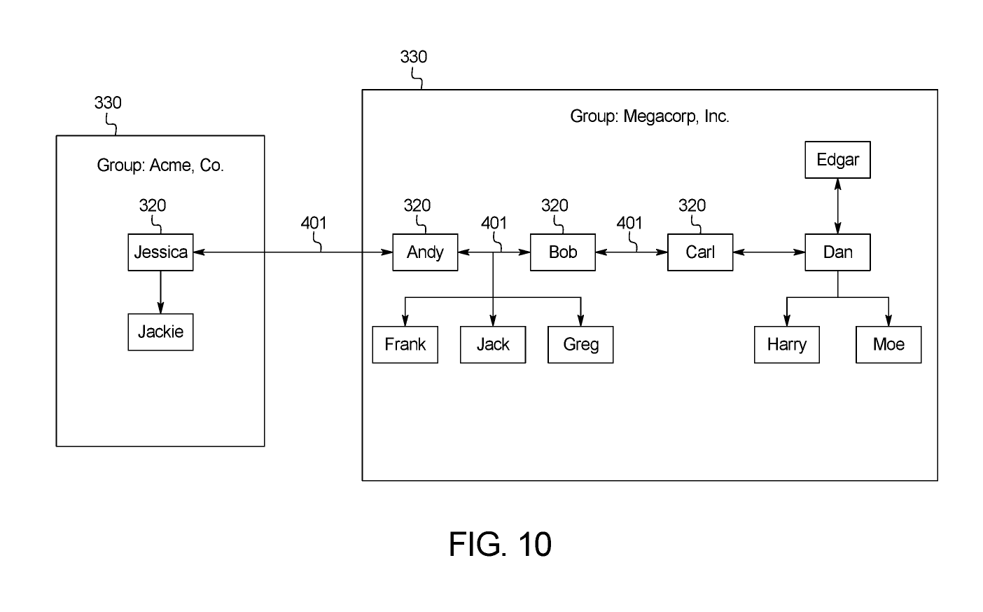

The functionality to note links between contacts is useful because it enables the system 10 to produce diagrams (see FIG. 10), reports, etc. which detail how a group of contact cards 320 are interlinked. For example, if a salesperson met with a corporate team in a boardroom and collected 10 peoples contact information, the end user may have all this information present in the form of business cards or even contacts in their smartphone. However, the salesperson does not have any clear record of who reports to who, who should be contacted regarding unpaid invoices, etc. If the information is collected and stored by the present system 10, in stark contrast, the salesperson can make note of who reports to who, who is the main point of contact, who is the designated backup to this main contact, etc. Further, the present system 10 enables the salesperson to have the whole corporate team's contact information, hierarchical structure, photos, etc. transferred to the salesperson's set of contact cards 320 automatically via the corporate teams use of the system 10.

The system 10 may also detect or suggest the link between two contact cards 320 automatically. For example, if contact cards 320 are created for “Jon Doe” and “Jane Doe” and they have the same home address and phone number, the system can determine these similarities (last name, address, phone number) and suggest to an end user that these two people are related and thus their respective contact cards 320 should be linked based off this relation.

Also shown in FIG. 4 is the ability to take private notes in the private information data field 214. Depending on how the system 10 is set-up, users may be able to enter private information concerning a given contact into the corresponding contact card 320. Again, using the sales person example above, sales people typically keep private notes on customers buying behavior, their likes/dislikes, etc. This information is useful and harkens back to the days of the rolodex where hand written notes would be kept on the back of business cards in the rolodex for reference by the sales person, etc. This ability is introduced to the computerized realm with the present system 10. End users can keep track of private information once they obtain or create a contact card 320 for a given end user. Other users may, or may not, be able to see or edit the private information data field 214 even if they can edit other data fields 213 of a contact card. Returning to the salesperson example, if they are out sick and need another salesperson to fill in for the day, they can, via the present system, transfer the contact cards 320 including the private notes in the private information data field 214 for their meetings that day in an instant using the present system 10. The system 10 may also be set up to never disclose the private information entered into the private information data field 214. An example of such a system 10 configuration could be utilized by a doctor if they were keeping track of patient contact information using the present system 10 and never wanted the information collected disseminated due to privacy laws.

FIG. 5 is a screen of the computerized contact management system's 10 GUI 310 in which all contact cards 320 an end user has collected can be viewed. As shown in FIG. 5, the All Cards screen 314 features a listing of all contact cards 320 collected by a given end user. The All Cards screen 314 enables end users to review the contact cards 320 in alphabetical order. When a user selects a contact card 320 to view, they are shown the contact information stored by the system 10 for that end user. This screen of the GUI 310 shows each contact card's 320 associated name and group 330 (if available). For example, the user has selected contact information for a user named “Dave” from the group 330 “Hatch”. Once selected, the end user can review the stored contact card 320 and update it if need be. An end user can also utilize this contact information displayed on the GUI to make a phone, email, SMS, etc. via the various corresponding functions of the end user device 110.

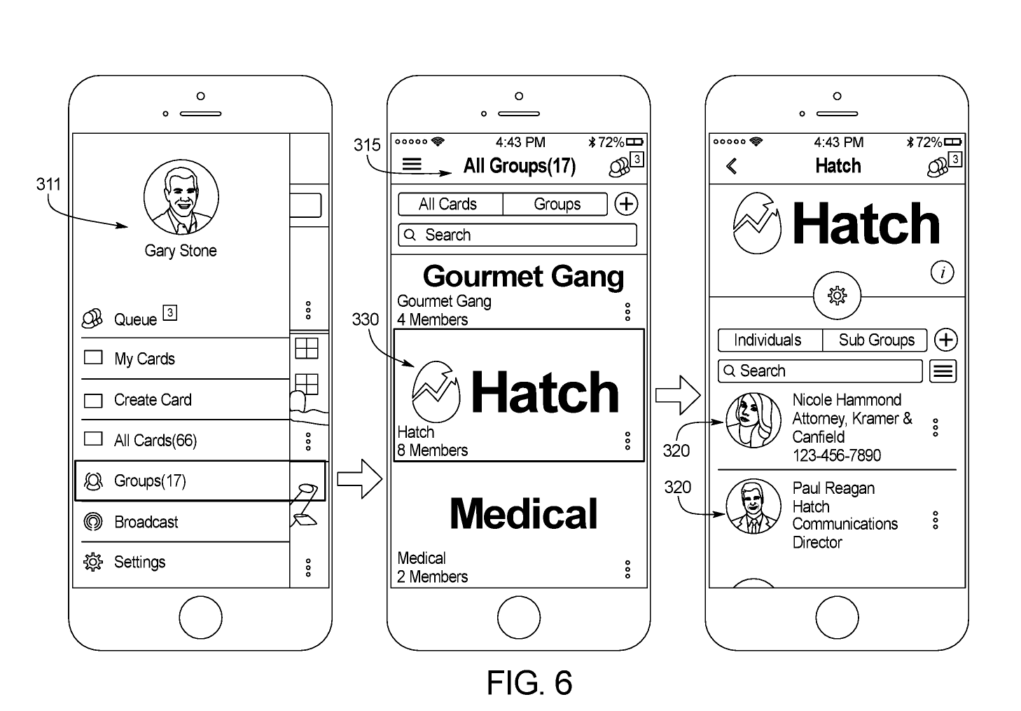

FIG. 6 is a screen of the computerized contact management system's 10 GUI 310 in which all groups 330 of contact cards 320 an end user has accumulated can be viewed. As shown in FIG. 6, the All Groups screen 315 enables end users to view groups of contact cards 320 they have stored. Each group 330 may related to anything a certain set of contact cards 320 have in common. This could be, for example, that all the contacts live in the same town, work for the same company, or attended the same conference. Contact cards for these users can be sorted and assigned to the groups manually by each end user (via the contact card creation screen 313) or can be sorted automatically based off organizational data, etc. Additionally, members within a group 330 can, in real time, update the contact cards 320 for some, or all of the contact cards present in a group 330 including relation between contacts, etc.

The settings for each group 330 may vary, but one helpful example is that of a child's birthday party. In modern times, a party such as this typically starts with a line of parents in front of the party venue as the parents dropping their kids off must manually enter contact data for the host parent and vice versa. The present system 10 enables the host parent to create a group 330 within the GUI 310. The party host may set the group 330 to include a passcode and leave the group open to all 330. When a visitor arrives at the party, that person can then locate the group 330 on their instance of the system's 10 GUI 310 and join by entering a designated passcode displayed at the entrance, printed on the invitation, etc. Once the passcode is entered, the system 10 will automatically swap contact cards 320 of the host and guest. For the host user, each guest's contact card 320 will automatically go into the group that was already created in their instance of the system 10 GUI 310. For each guest, the host's card may remain in their queue until placed into a group 330. Alternatively, the group 330 (and/or the contact cards 320 therein) created by the host may also be transmitted to all members of the group 330 providing contact cards 320 of all the parents dropping off kids at the party in case of emergency, etc. Additionally, depending on group settings, all members of a designated group may be able to update their own contact cards 320 and the contact cards 320 of other group members. This functionality may be irrelevant for a party which lasts a few hours, but could be very helpful for organizing a soccer team, PTA meetings, etc.

It should be noted that the updates to contact cards 320 within a given group 330 propagated by the system 10 is just one manner in which the system 10 may keep the contact card 320 information for each user's card 320 up to date for all other users. The present system 10 may perform an update of the contact card 320 information at an individual level (e.g., send updates to one other user or a select number of users), group level (e.g., send updates to multiple other users contained within a group or group(s) 330), or system wide level (update a given card for all system users that have it, no matter the group 330 the card 320 is assigned to).

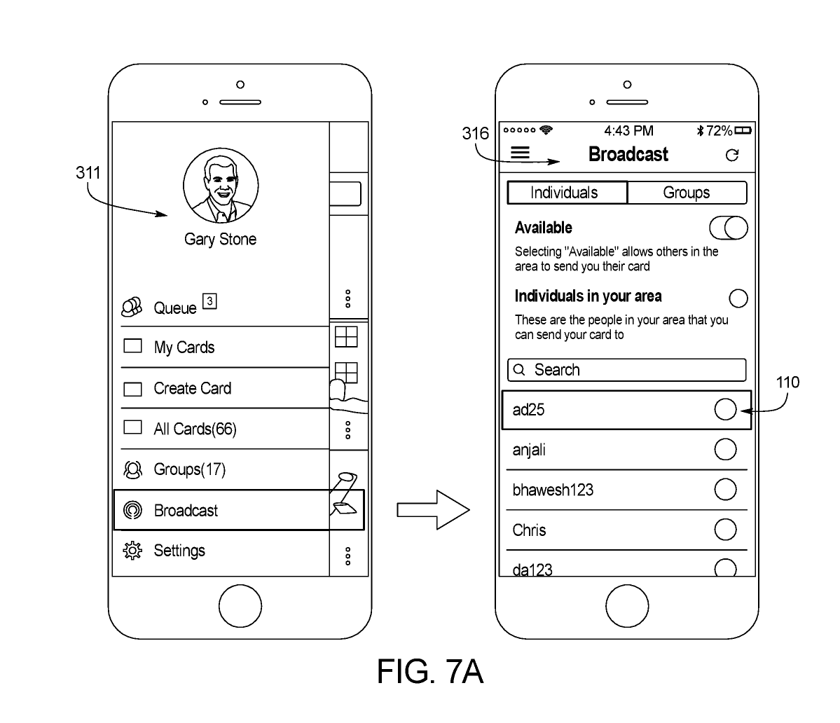

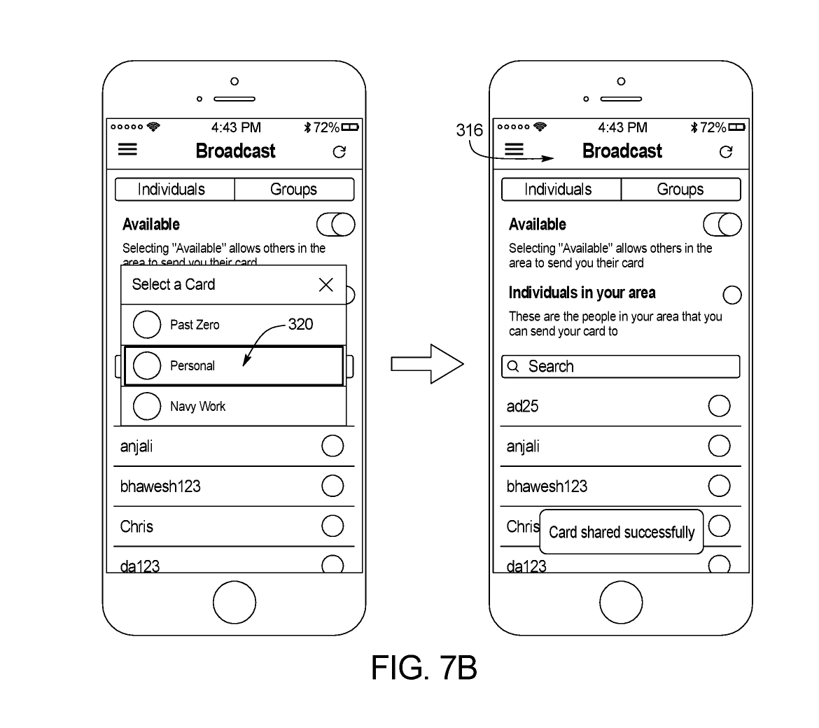

FIG. 7A-7B (collectively FIG. 7) is a screen of the system 10 GUI 310 in which an end user may share their contact card 320 with other system 10 user(s). As shown in FIG. 7, the broadcast contact information screen 316 enables an end user device 110 to broadcast a contact card to other end users of the system 10. Broadcast of the contact card 320, in this example, may be carried out by a personal area network (e.g., INSTEON, IrDA, Wireless USB, Bluetooth, Z-Wave, ZigBee, Body Area Network, etc.) but can also be transmitted via other communication protocols with there being no functional requirement that end users be physically close to one another in other system 10 embodiments. When an end user wishes to share their contact information with a single other user, they access the broadcast information screen 316 and set themselves as “Available”. This setting activates the communication sub-system of the end user device 110 (for example, turns on Bluetooth access for the system 10) and the GUI 10 then lists other end users sharing their contact cards in the general area. An end user then selects one of these other users, selects which contact card 320 they wish to share, and the system 10 transmits the contact card 320 data between the two end users. A confirmation message may be displayed by the GUI 310 regarding transmission and/or receipt of the contact card information 320.

An example of this functionality may be that of two doctors meeting on a ski trip. One doctor may be from Alaska and the other from Florida. If they meet in the elevator at a ski lodge, they can converse briefly and agree to exchange information. To do so, they need to simply take out their end user devices 110, access the broadcast contact information screen 316, locate each other in the list of available users, and allow the system 10 to transfer the contact information automatically. It should be noted that transmission can be even further simplified in other embodiments of the system via the use of near field communication (NFC) transmission, etc. to automatically transmit contact card 320 information when two end user devices 110 are touched together, etc.

Another example of an instance of the system 10, where in physical proximity is not required, could be that of an e-conference. Many modern meetings, conferences, etc. are held online and attendees make business connections virtually. The present system 10 may still be utilized to obtain contact cards 320 of the attendees of an e-conference with transmission of the contact card(s) 320 occurring over the internet or any other functional means of long distance data transmission.

It should be noted the present system 10 can transfer as few as one contact card 320 between users up to the enterprise level (e.g., thousands, millions, billions, etc. of contact cards (sets of contact information) 320 transferred) depending on the system's 10 implementation.

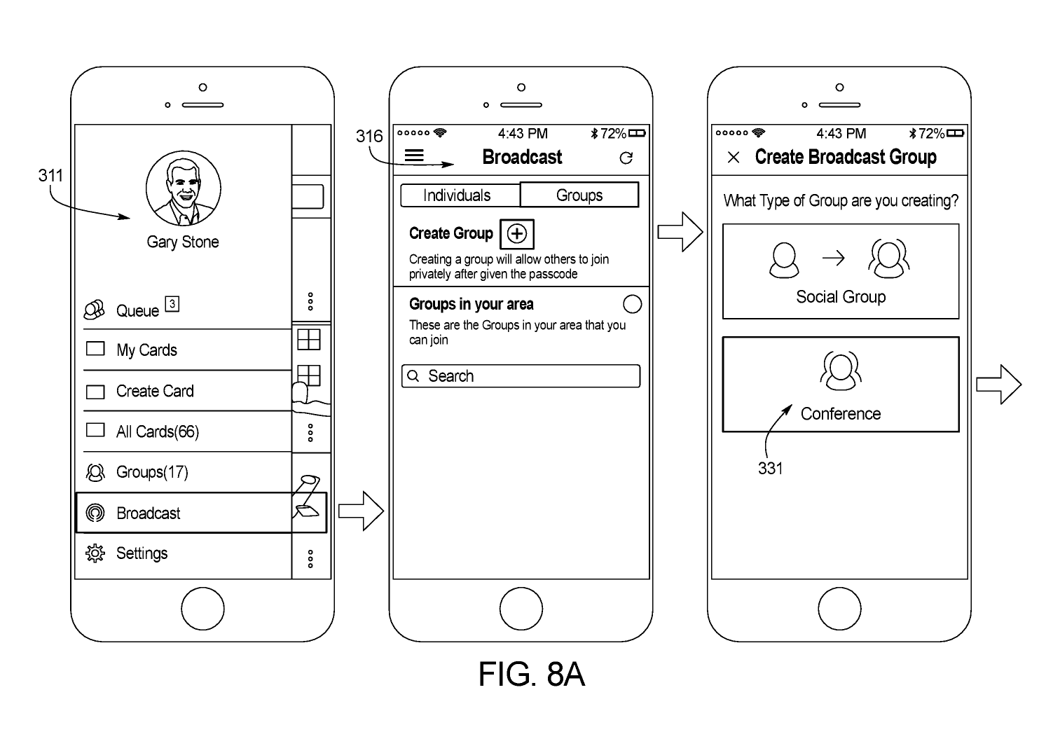

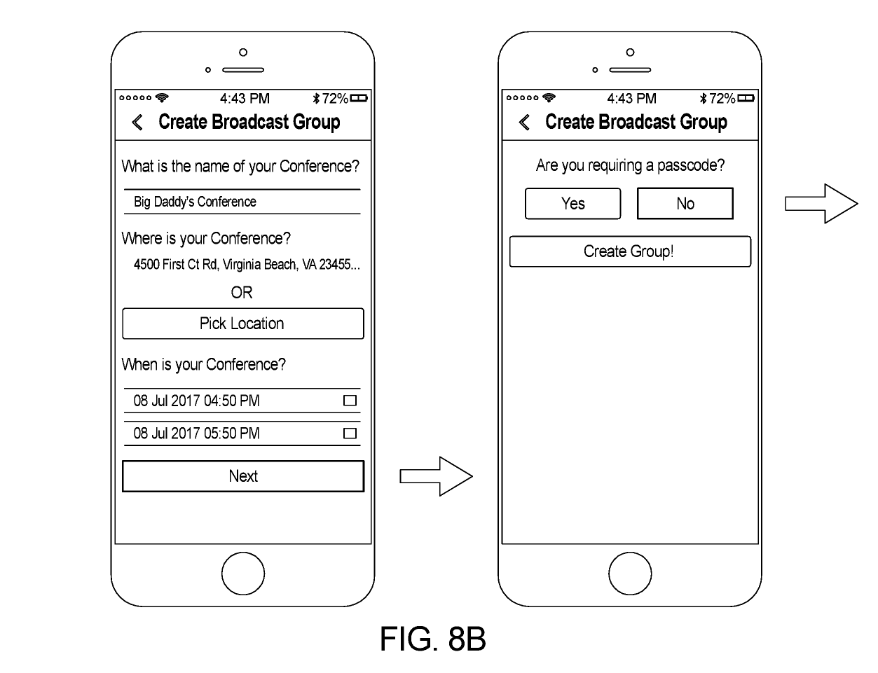

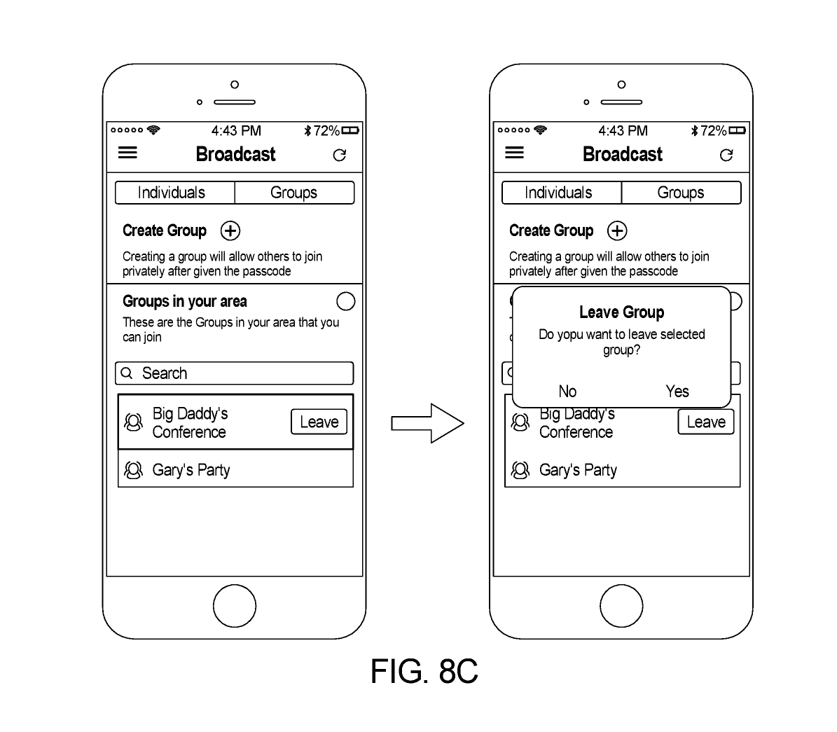

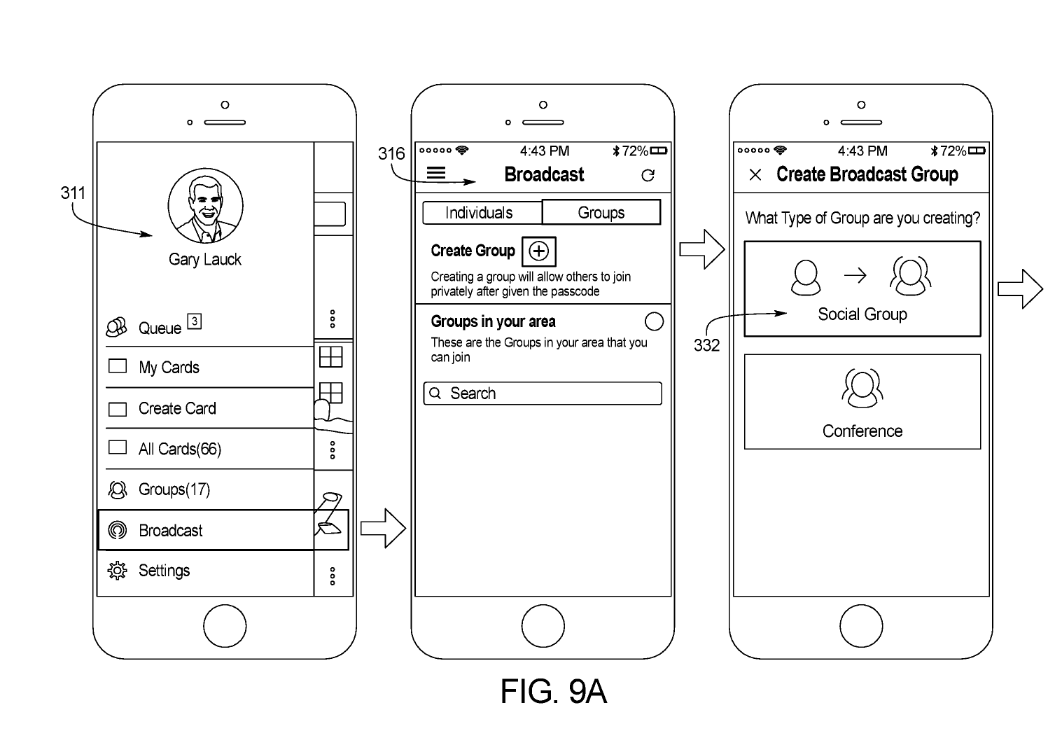

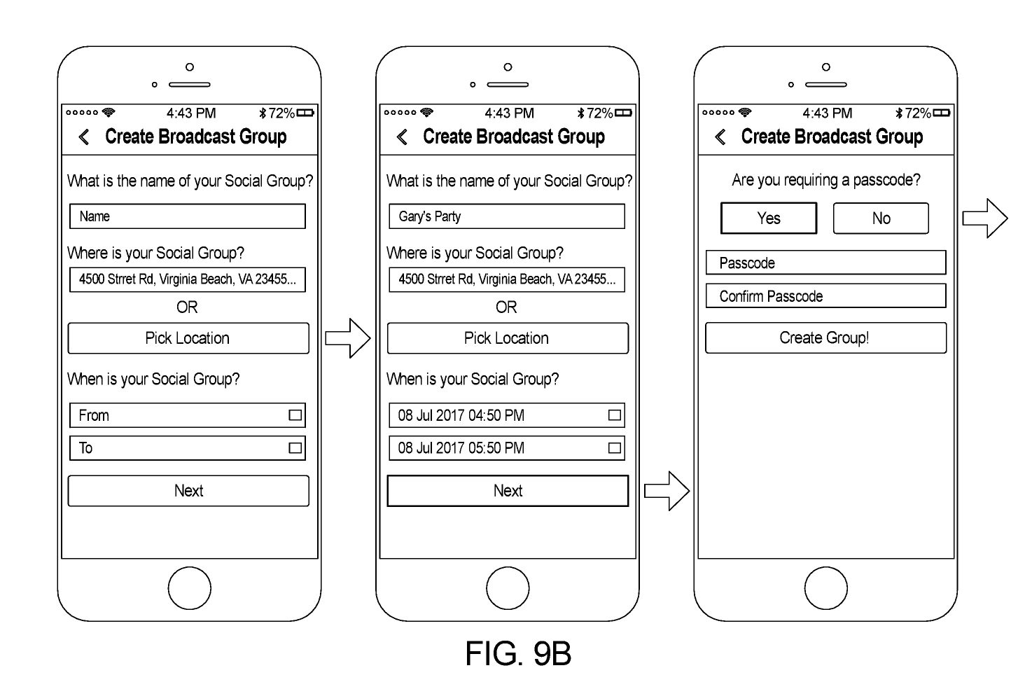

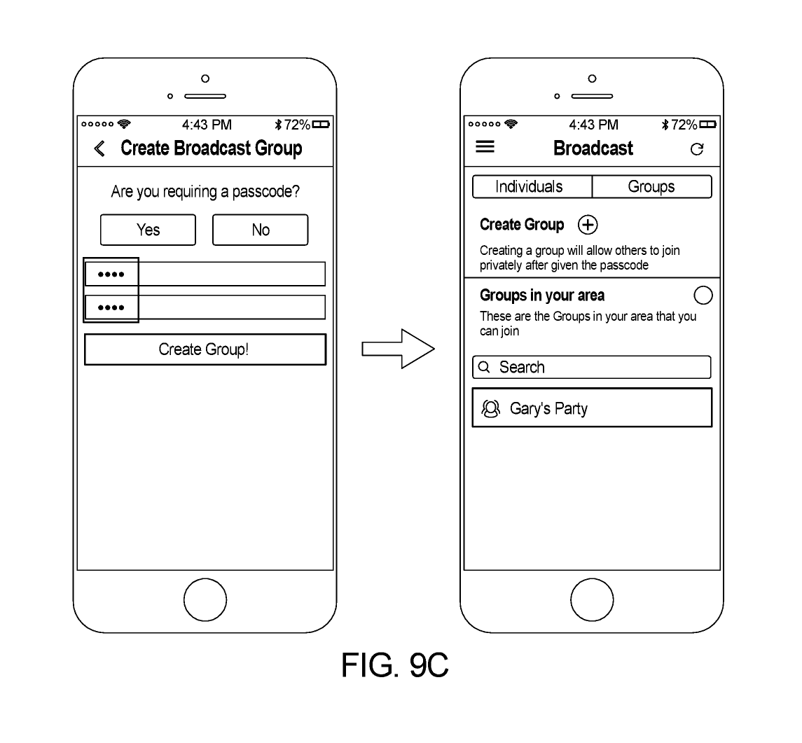

FIG. 8A-8C (collectively FIG. 8) is a group 330 creation screen of the system 10 GUI 310 utilized to create a conference group 330. To create a group 330, an end user first accesses the broadcast screen 316 and then elects to create a group 330. As shown in FIG. 8 (and subsequently FIG. 9) the embodiment of the system 10 shown enables the creation of two types of groups. A conference group 331 enables a user to set up a group which is accessible by all attendees of a conference, etc. The conference group 331 is set up with temporal settings and can also be restricted to a certain geographical location. For example, a conference for the corporation “Big Daddy's Foods, Inc.” might have a conference group 331 set up with the name “Big Daddy's Conference”. This conference group 331 may have time frame set up for when it is accessible (e.g., 8 AM until 5 PM on 8 Jul. 2017) and well as a geographical restriction (e.g., Tucson Hilton Hotel) placed upon the group. The geographical restriction placed may be determined off global positioning (GPS) data, geo-fencing, or any other functional means which are capable of identifying the physical location of an end user device 310. Once set up on the system 10, attendees of Big Daddy's Foods conference will be able to join the conference group 331 during the day of the conference if they are in physical attendance. End users can also leave a joined group 330 from the group creation screen as illustrated in FIG. 8. Depending on system 10 setting, when an end user opts to leave a group 330, their contact card 320 may (or may not) be erased from the contact card 320 collections of other group 330 members (if the contact card 320 was obtained only from the group 330).

The conference group 331 is set up, in this embodiment, to transfer contact information of each end user who joins the group with all other end users in attendance. Alternatively, if the end user was, for example, giving a sales pitch at a conference, they may not want to have every attendee exchange contact information amongst themselves but rather collect all the attendee's contact information and provide to them only the speaker (the salespersons) contact information. Settings such as this may be set and changed via the GUI 310.

FIG. 9A-9C (collectively FIG. 9) is a group 330 creation screen of the system 10 GUI 310 utilized to create a social group 332. As mentioned above, to create a group 330, an end user first accesses the broadcast screen 316 and then elect to create a group 330. A social group 332, in this example, may be set up to transmit a party host's contact card 320 data to guests, with the host receiving all guest's contact cards 320 in one convenient location (the social group 320). It should be noted in this example; the contact card 320 information of the guests will not be shared with other guests and only the host will have access to the contact information for all guests. Each guest may be able to still update their own contact card 320, but access to other guest's contact cards 320 is restricted. Like the conference group 331 example above, temporal and geographical restrictions may be placed on those joining the group 330. Additionally, in the example shown, the social group 332 created for “Gary's Party” also has a passcode in place. This passcode may be given out ahead of time or printed and posted somewhere at the party to ensure the end user(s) joining the group 330 are authorized to do so.

It should be noted the difference between a conference group 331 and social group 332 are drawn to highlight different functionalities possible with the present system. These groups (331 and 332) are two of many different types of contact card groups 330 which may be set up and managed by the present system 10. The functionalities highlighted by each example of a group 330 are in no way limiting on other embodiments of the system 10 featuring groups 330.

FIG. 10 is a diagram of how the system 10 maps contacts based on hierarchical data. As shown in FIG. 10, the present system 10 may track the roles of various people within a group 330 of contact cards 320 (and beyond). Previously discussed in FIG. 4, the present system 10 may keep track of how various contact cards 320 collected by the system 10 are related to one another. The term “relation” can mean actual blood relation but also applies to business organizational data (e.g., reporting structure, designated backup people, etc.), sports team structures, clubs, military chain of command, groups of friends, etc. In the example shown, two companies, Megacorp, Inc. and Acme, Co. have their organizational structure mapped out based off information collected by the system 10. Megacorp has three levels of structure mapped by the system 10. Edgar is noted as being the boss of Dan (top level); Dan, Carl, Bob and Andy are noted as being peers (middle management); and Harry and Moe report to Dan (support staff). Frank, Jack, and Greg are noted as being support staff, but rather than reporting to anyone in particular, the system 10 has placed them below Andy and Bob. The connection 401 between Andy and Bob represents their relation to one another. In this example, that relation is that they are noted as being members of the same organization with the same title (Middle Manager of Sales). Frank, Jack, and Greg are noted in the system 10 as reporting to the Middle Manager of Sales and thus Frank, Jack, and Greg show up as reporting to Andy and Bob.

Continuing with this example, Dan's contact card 320 information notes that he is the Middle Manager of Operations and the system 10 has also separately received the contact card 320 information for Edgar. Edgar notes he is the Director of Operations for Megacorp, Inc. in his contact card and thus the system 10 can determine Dan reports to Edgar. The system 10 carries out this same deduction for Harry and Moe (Assistant Operation Managers) and notes them as reporting to Dan. It should be noted that the system 10 can infer relationships in some embodiments while in others, companies, groups, etc. can send their organizational data out to users for their reference. For example, if a lawyer was to meet with a company, the company could send the lawyer all of their employees contact cards 320 along with the connection 401 between each card 320 (e.g., who reports to who). This way companies can clearly articulate a chain of command when it is needed and quickly update this hierarchical information if a team member leaves the organization, is promoted, etc. (assuming the system 10 is set up to allow such updates).

Also shown in FIG. 10, is the system's 10 ability to determine and track links between two groups 330 of contact cards 320. In the example shown, an employee of a second company Acme, Co. is linked to an employee of the first company Megacorp, Inc. The connection 401 is between Jessica from Acme, Co. and Andy from Megacorp, Inc. This connection 401 could be any sort of relation, but in this example, is that of a designated sales representative. Andy has been noted as being the primary sales representative for Jessica on his contact card 320. Jessica is noted as being the manager of purchasing for Acme, Co. on her card 320. Jackie, separately, has provided her contact card 320 which states she is assistant purchasing manager for Acme Co. Thus, the system can discern there is a connection 401 between Acme, Co. and Megacorp, Inc. and that Jackie reports to Jessica. The system 10 may be set up to act on this information so that if, for example, Jessica was out of the office, the system 10 might suggest Andy contact Jackie instead.

Another example of the hierarchy mapping functionality of the system 10 is its use for a family reunion. Many extended families are quite large and not particularly close. While immediate nuclear families may converse regularly with their aunts, uncles, cousins, etc. when it comes to second cousins, step-siblings, etc. the ability to keep track of all members of a family can be quite difficult. The present system 10 helps address this issue by enabling creation of a group (or groups) 330 of contact cards 320 which can be linked together manually by end users or the system 10 itself automatically (or both). For example, if Gary attends a family reunion, he can create a group 330 of contact cards 320 for him and his wife and daughter. Prior to attending an upcoming family reunion, a member of Gary's extended family can also create a separate group 330 for Gary's entire extended family to share contact cards 320. Once this extended family group 330 is created, Gary can then upload his (or his whole groups) contact cards 320 to the extended family group 330. Gary can then review the contact cards 320 within the extend family group 330 to establish relation to some of the other group members. To do this Gary may update his own contact card 320 (or anyone else's card 320, depending on the group 330 settings) to reflect a connection 401 to his sisters, etc. The system 10 can then, from the group's 330 contact cards 320, create a viewable family tree showing how those attending the family reunion are related.

The hierarchy mapping functionality of the system 10 described above is simplistic, with the system 10 being capable of much more in-depth analysis and more user-friendly presentation of data. For example, in the family reunion scenario, any contact card 320 an end user selects within the system 10 GUI 310 (showing the hierarchy tree) may be brought to the forefront and be centered in the middle of the GUI 310. The contact card's 320 associated parent contact card(s) 320 may show connection(s) 401 from above, sibling cards 320 the side, and children cards 320 below. Exterior connections (e.g., extended family) may be reflected by connections 401 leading off the GUI 310 which an end user can scroll, click, maneuverer, etc. and bring into view of the GUI 310. If and end user was to, for example, select a parent contact card 320 of another card 320, the parent contact card 320 would now go to the middle of the GUI 310 and the parent card's 320 associated siblings, parents, children, etc. would populate around them.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A contact management system comprising:
a first user device including a first processor and a first memory coupled to the first processor, wherein the first memory stores program instructions that when executed by the first processor cause the first processor to:
display a first graphical user interface through which a first set of contact information is accessed, the first set of contact information including first data relating to each of a plurality of contacts, the first data relating to each of the plurality of contacts including at least:
a unique contact identifier data field;
a user selectable group assignment data field; and
additional data fields related to the unique contact identifier; and
provide a first group assignment user control through the first graphical user interface through which a first user assigns at least two of the unique contact identifiers to a first group of contact identifiers, the first group of contact identifiers including a first unique group identifier; and
a second user device including a second processor and a second memory coupled to the second processor, wherein the second memory stores program instructions that when executed by the second processor cause the second processor to:
display a second graphical user interface through which a second set of contact information is accessed, the second set of contact information including second data relating to each of a plurality of contacts, the second data relating to each of the plurality of contacts including at least:
a unique contact identifier data field;
a user selectable group assignment data field; and
additional data fields related to the unique contact identifier;
provide a second group assignment user control through the second graphical user interface through which a second user assigns two of the unique contact identifiers to a second group of contact identifiers, the second group of contact identifiers including the first unique group identifier;
provide a share group user control through the second graphical user interface through which the second user selects the second group of contract identifiers and, in a single user action, the second user device shares to the first user device the data relating to each of the plurality of contacts assigned to the second group with the first user device, thereby updating the data relating to each of the plurality of contacts assigned to the second group in the first set of contact information accessible through the first user device.

2. The contact management system of claim 1 wherein each of the first set of contact information and the second set of contact information include a common unique contact identifier.

3. The contact management system of claim 1 wherein, when the second user device shares to the first user device the data relating to each of the plurality of contacts assigned to the second group with the first user device, all data related to the plurality of contacts assigned to the second group is shared.

4. The contact management system of claim 1 wherein, when the second user device shares to the first user device the data relating to each of the plurality of contacts assigned to the second group with the first user device, less than all data related to the plurality of contacts assigned to the second group is shared.

5. The contact management system of claim 1 wherein the first graphical user interface provides an update control mechanism through which the first user enables edits to be pushed to the second user device.

6. The contact management system of claim 5 wherein, when the first user enables edits to be pushed to the second user device, the edits are automatically pushed to the second user device when the edits are made through the second user device.

7. The contact management system of claim 5 wherein, when the first user enables edits to be pushed to the second user device, the edits are manually pushed to the second user device.

8. The contact management system of claim 1 wherein the first graphical user interface provides an update control mechanism through which the first user enables edits to be received from the second user device.

9. The contact management system of claim 8 wherein, when the first user enables edits to be received from the second user device, the edits are automatically received from the second user device when the edits are made through the second user device.

10. The contact management system of claim 8 wherein, when the first user enables edits to be received from the second user device, the edits are manually received from the second user device.

11. The contact management system of claim 1 wherein the first data relating to each of the plurality of contacts and the second data relating to each of the plurality of contacts includes data defining one or more hierarchical relationships between at least two unique contact identifiers.

12. The contact management system of claim 11 wherein the first graphical user interface includes a display hierarchy control that, when selected, displays a visual representation of the one or more hierarchical relationships between the at least two unique contact identifiers.

13. The contact management system of claim 12 wherein the first graphical user interface displays only the one or more hierarchical relationships between the at least two unique contact identifiers for a selected group of contact identifiers.
